(19) United States
(12) Patent Application Publication
(10) Pub. No.: US 2014/0202701 A1
(43) Pub. Date: Jul. 24, 2014

(54) Iron Control Agents and Related Methods

(71) Applicant: HALLIBURTON ENERGY SERVICES, INC., Houston, TX (US)

(72) Inventors: Prajakta Ratnakar Patil, Pune (IN); Yogesh Kumar Choudhary, Rajasthan (IN)

(73) Assignee: Halliburton Energy Services, Inc., Houston, TX (US)

(21) Appl. No.: 13/748,301

(22) Filed: Jan. 23, 2013

(51) Int. Cl. E21B 43/26; C09K 8/528

(52) U.S. Cl. CPC E21B 43/26; C09K 8/528
USPC 166/307; 507/260; 166/308.1

(57) ABSTRACT

The disclosure herein relates to iron control during subterranean operations, and more specifically, to reducing iron precipitation during subterranean operations to avoid formation damage; a method includes providing an acidizing treatment fluid that includes a polyepoxysuccinic acid and an acidizing agent, and placing the acidizing treatment fluid in a subterranean formation.

### BACKGROUND

The disclosure herein relates to iron control during subterranean operations, and more specifically, to reducing iron precipitation during subterranean operations to avoid potential formation damage.

Acidizing and fracturing treatments using aqueous acidic solutions commonly are carried out in subterranean formations (including those that contain hydrocarbons as well as those that do not) that are penetrated by well bores to accomplish a number of purposes, one of which may be to bypass or remove the damage and increase the permeability of the formation. The resultant increase in formation permeability normally results in an increase in the recovery of hydrocarbons from the formation.

Acidizing techniques may be carried out as “matrix acidizing” procedures or as “acid fracturing” procedures. Generally, in acidizing treatments, aqueous acidic solutions are introduced into the subterranean formation under pressure so that the acidic solution flows into the pore spaces of the formation to remove near-well formation damage and other substances that may block free flow of hydrocarbons into the well bore. The acidic solution reacts with acid-soluble materials contained in the formation, which results in an increase in the size of the pore spaces and an increase in the permeability of the formation. This procedure commonly enhances production by increasing the effective well radius at the point where the acid interacts with the surrounding formation. When performed at pressures above the pressure required to fracture the formation, the procedure is often referred to as acid fracturing.

Fracture-acidizing involves the formation of one or more fractures in the formation and the introduction of an aqueous acidizing fluid into the fractures to etch the fractures' faces whereby flow channels are formed when the fractures close. The aqueous acidizing fluid also enlarges the pore spaces in the fracture faces and in the formation. In fracture-acidizing treatments, one or more fractures are produced in the formation and the acidic solution is introduced into the fracture to etch flow channels in the fracture face. The acid also enlarges the pore spaces in the fracture face and in the formation. The use of the term “acidizing” herein refers to both types of acidizing treatments, and more specifically, refers to the general process of introducing an acid down hole to perform a desired function, e.g., to acidize a portion of a subterranean formation or any damage contained therein.

Although acidizing a portion of a subterranean formation can be very beneficial in terms of permeability, conventional acidizing systems have significant drawbacks. One problem associated with acidizing subterranean formations is the corrosion caused by the acidic solution to any metal goods (such as tubular goods) in the well bore and the other equipment used to carry out the treatment. For example, conventional acidizing fluids, such as those that contain organic acids, hydrochloric acid or a mixture of hydrofluoric and hydrochloric acids, have a tendency to corrode tubing, casing and down hole equipment, such as gravel pack screens and down hole pumps, especially at elevated temperatures. The corrosion problem can be exacerbated by the elevated temperatures encountered in deeper formations. The increased corrosion rate of the ferrous/ferric and other metals in the tubular goods and other equipment may result in quantities of the acidic solution being neutralized before it ever enters the subterranean formation. This partial neutralization of the acid results in the production of quantities of metal ions which are highly undesirable in the subterranean formation.

Iron control agents have been employed with mixed success to keep the metal ions in soluble form and prevent the precipitation of damaging compounds. Such agents include, for example, ethylenediaminetetraacetic acid (EDTA) and citric acid. Iron (III), i.e., ferric ion, has a tendency to form iron hydroxide precipitates from a pH of about 7 and higher. This particular precipitate is problematic due, in part, to the propensity to form intractable sludges and damage to the subterranean formation.

### SUMMARY OF THE INVENTION

The disclosure herein relates to iron control during subterranean operations, and more specifically, to reducing iron precipitation during subterranean operations to avoid formation damage.

In some embodiments, the disclosure herein provides a method comprising providing an acidizing treatment fluid comprising a polyepoxysuccinic acid and an acidizing agent, and placing the acidizing treatment fluid in a subterranean formation.

In other embodiments, the disclosure herein provides a method comprising providing a treatment fluid comprising a polyepoxysuccinic acid, and placing the treatment fluid in a subterranean formation comprising ferric ion, ferrous ion, and mixtures thereof, whereby the treatment fluid sequesters ferric ion, ferrous ion, and mixtures thereof from the subterranean formation to prevent sludging in the subterranean formation.

In still other embodiments, the disclosure herein provides a method comprising providing a treatment fluid comprising a polyepoxysuccinic acid, placing the treatment fluid in a subterranean formation comprising a sludge, the sludge comprising ferric ion, ferrous ion, and mixtures thereof, whereby the treatment fluid sequesters ferric ion, ferrous ion, and mixtures thereof from the sludge resulting in a broken down sludge in the subterranean formation, and removing the broken down sludge from the subterranean formation.

The features and advantages of the disclosure herein will be readily apparent to those skilled in the art upon a reading of the description of the preferred embodiments that follows.

### DETAILED DESCRIPTION

The disclosure herein relates to iron control during subterranean operations, and more specifically, to reducing iron precipitation during subterranean operations to avoid formation damage.

Among the numerous advantages, the disclosure herein provides a heretofore unrecognized class of iron control agent based on polyepoxysuccinic acid (PESA) which may improve the sequestration of iron and other metals. In some embodiments, PESA may also be used to sequester other transition metals as well as calcium and magnesium. PESA is a synthetic polymer which may provide a non-hazardous, biodegradable and generally environmentally friendly means to control iron and other undesirable metals present during subterranean operations, such as acidizing operations. As indicated in the Example below, treatment fluids comprising PESA may demonstrate good iron control characteristics even at temperatures of about 200° F. (93.3° C.).

In some operations, treatment fluids comprising PESA may be used as part of a pre-treatment operation in iron-containing formations as a means of preventing or reducing sludge formation. In other embodiments, treatment fluids comprising PESA can be used as part of a remedial operation to break up existing sludges. Without being bound by theory, it is presently believed that iron-control agents such as PESA may prevent the formation of particulate insoluble iron salts by complexing or chelating ferrous iron or reducing ferric iron to ferrous iron. PESA may also prevent the oxidation of ferrous to ferric iron. Ferrous iron is commonly found in sludge formed from acidizing oil and gas wells. Iron in the sludge may come from naturally occurring iron in the subterranean formation or from iron in tubular goods used in the drilling and/or production of the well. Again, without being bound by theory it has been postulated that PESA may enable emulsion breakers to resolve sludge more promptly than with conventional methods by converting ferric iron to ferrous iron or preventing the formation of ferric iron. In aqueous solution, ferric iron is insoluble and aggravates resolution of the sludge. Other advantages will be apparent to those of ordinary skill in the art.

In some embodiments, the disclosure herein provides methods comprising providing acidizing treatment fluids comprising polyepoxysuccinic acid and acidizing agents, and placing the acidizing treatment fluid in a subterranean formation.

PESA is often commercially provided as a light yellow transparent liquid with about 40.7% activity, i.e., the active concentration of PESA in aqueous form. It has been employed as a corrosion and scale inhibitor in circulating water and desalination systems. PESA may be given by the following general chemical formula:

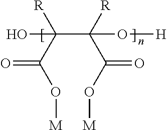

wherein n may range from about 2 to about 10, R may be hydrogen or C1-C4 alkyl, and M may be an ion selected from hydrogen, sodium, potassium, and ammonium.

In some embodiments, the polyepoxysuccinic acid may be present in a range from about 0.1 percent by weight of the acidizing treatment fluid to about 10 percent by weight of the acidizing treatment fluid. In some embodiments, PESA may be present in the treatment fluids in an amount ranging from a lower limit of about 0.1%, 0.5%, 1.0%, 2%, 3%, 4%, 5%, or 6% by weight of the injection fluid to an upper limit of about 5%, 6%_{,} 7%_{,} 8%, 9%, or 10% by weight of the treatment fluid, and wherein the percentage of PESA may range from any lower limit to any upper limit and encompass any subset between the upper and lower limits. Some of the lower limits listed above are greater than some of the listed upper limits, one skilled in the art will recognize that the selected subset will require the selection of an upper limit in excess of the selected lower limit.

In some embodiments, methods of the invention may employ treatment fluids comprising PESA at temperatures in the subterranean formation, which may be in a range from about ambient surface temperature to about 260° C.

The acidizing treatment fluid and other treatment fluids disclosed herein may comprise an aqueous base fluid. Aqueous base fluids suitable for use in the treatment fluids of the disclosure herein may comprise fresh water, saltwater (e.g., water containing one or more salts dissolved therein), brine (e.g., saturated salt water), seawater, or combinations thereof. Generally, the water may be from any source, provided that it does not contain components that might adversely affect the stability and/or performance of the treatment fluids of the disclosure herein. In certain embodiments, the density of the aqueous base fluid can be adjusted, among other purposes, to provide additional particulate transport and suspension in the treatment fluids used in the methods of the disclosure herein. In certain embodiments, the pH of the aqueous base fluid may be adjusted (e.g., by a buffer or other pH adjusting agent), among other purposes, to provide an acidizing treatment fluid. One of ordinary skill in the art, with the benefit of this disclosure, will recognize when such density and/or pH adjustments are appropriate. In some embodiments, the pH range may be from about 1 to about 11.

In some embodiments, the treatment fluids for use in conjunction with the disclosure herein may be foamed. As used herein the term foam refers to a two-phase composition having a continuous liquid phase and a discontinuous gas phase. In some embodiments, treatment fluids for use in conjunction with the disclosure herein may comprise an aqueous base fluid, a gas, and a foaming agent.

Suitable gases for use in conjunction with the disclosure herein may include, but are not limited to, nitrogen, carbon dioxide, air, methane, helium, argon, and any combination thereof. One skilled in the art, with the benefit of this disclosure, should understand the benefit of each gas. By way of non-limiting example, carbon dioxide foams may have deeper well capability than nitrogen foams because carbon dioxide foams have greater density than nitrogen gas foams so that the surface pumping pressure required to reach a corresponding depth is lower with carbon dioxide than with nitrogen. Moreover, the higher density may impart greater proppant transport capability, up to about 12 lb of proppant per gal of fracture fluid.

In some embodiments, the quality of the foamed treatment fluid may range from a lower limit of about 5%, 10%, 25%, 40%, 50%, 60%, or 70% gas volume to an upper limit of about 95%, 90%, 80%, 75%, 60%, or 50% gas volume, and wherein the quality of the foamed treatment fluid may range from any lower limit to any upper limit and encompass any subset therebetween. Most preferably, the foamed treatment fluid may have a foam quality from about 50% to about 85%, or about 80% to about 95%.

Suitable foaming agents for use in conjunction with the disclosure herein may include, but are not limited to, cationic foaming agents, anionic foaming agents, amphoteric foaming agents, nonionic foaming agents, or any combination thereof. Non-limiting examples of suitable foaming agents may include, but are not limited to, surfactants like betaines, sulfated or sulfonated alkoxylates, alkyl quaternary amines, alkoxylated linear alcohols, alkyl sulfonates, alkyl aryl sulfonates, C₁₀-C₂₀ alkyldiphenyl ether sulfonates, polyethylene glycols, ethers of alkylated phenol, sodium dodecylsulfate, alpha olefin sulfonates such as sodium dodecane sulfonate, trimethyl hexadecyl ammonium bromide, and the like, any derivative thereof, or any combination thereof. Foaming agents may be included in foamed treatment fluids at concentrations ranging typically from about 0.05% to about 2% of the liquid component by weight (e.g., from about 0.5 to about 20 gallons per 1000 gallons of liquid).

In some embodiments, the acidizing agent comprises one selected from the group consisting of hydrochloric acid, hydrofluoric acid, acetic acid, formic acid, sulfamic acid, and chloroacetic acid, and combinations thereof. In some embodiments, the acidizing agent may be any inorganic acid. The term “inorganic acid” refers to any acidic compound that does not comprise a carbon atom. Examples of suitable inorganic acids include, but are not limited to, hydrochloric acid, hydrofluoric acid, hydrobromic acid, sulfuric acid, phosphoric acid, and nitric acid. In some embodiments, the acidizing agent may comprise an organic acid. Examples of suitable organic acids include, but are not limited to, formic acid, acetic acid, citric acid, glycolic acid, lactic acid, 3-hydroxypropionic acid, a C₁ to C₁₂ carboxylic acid, an aminopolycarboxylic acid such as hydroxyethylethylenediamine triacetic acid, and combinations thereof.

In some embodiments, the acidizing agent is provided in a retarded release formulation. In some such embodiments, the retarded release formulation comprises a gelling agent. The gelling agents suitable for use in the disclosure herein may comprise any substance (e.g., a polymeric material) capable of increasing the viscosity of the treatment fluid. In certain embodiments, the gelling agent may comprise one or more polymers that have at least two molecules that are capable of forming a crosslink in a crosslinking reaction in the presence of a crosslinking agent, and/or polymers that have at least two molecules that are so crosslinked (i.e., a crosslinked gelling agent). The gelling agents may be naturally-occurring gelling agents, synthetic gelling agents, or a combination thereof. The gelling agents also may be cationic gelling agents, anionic gelling agents, or a combination thereof. Suitable gelling agents include, but are not limited to, acrylates, polysaccharides, biopolymers, and/or derivatives thereof that contain one or more of these monosaccharide units: galactose, mannose, glucoside, glucose, xylose, arabinose, fructose, glucuronic acid, or pyranosyl sulfate. Examples of suitable polysaccharides include, but are not limited to, guar gums (e.g., hydroxyethyl guar, hydroxypropyl guar, carboxymethyl guar, carboxymethylhydroxyethyl guar, and carboxymethylhydroxypropyl guar (“CMHPG”)), cellulose derivatives (e.g., hydroxyethyl cellulose, carboxyethylcellu lose, carboxymethylcellulose, and carboxymethylhydroxyethylcellulose), xanthan, scleroglucan, succinoglycan, diutan, and combinations thereof. In certain embodiments, the gelling agents comprise an organic carboxylated polymer, such as CMHPG.

Suitable synthetic polymers include, but are not limited to, 2,2′-azobis(2,4-dimethyl valeronitrile), 2,2′-azobis(2,4-dimethyl-4-methoxy valeronitrile), polymers and copolymers of acrylamide ethyltrimethyl ammonium chloride, acrylamide, acrylamido and methacrylamido-alkyl trialkyl ammonium salts, acrylamidomethylpropane sulfonic acid, acrylamidopropyl trimethyl ammonium chloride, acrylic acid, dimethylaminoethyl methacrylamide, dimethylaminoethyl methacrylate, dimethylaminopropyl methacrylamide, dimethylaminopropylmethacrylamide, dimethyldiallylammonium chloride, dimethylethyl acrylate, fumaramide, methacrylamide, methacrylamidopropyl trimethyl ammonium chloride, methacrylamidopropyldimethyl-n-dodecylammonium chloride, methacrylamidopropyldimethyl-n-octylammonium chloride, methacrylamidopropyltrimethylammonium chloride, methacryloylalkyl trialkyl ammonium salts, methacryloylethyl trimethyl ammonium chloride, methacrylylamidopropyldimethylcetylammonium chloride, N-(3-sulfopropyl)-N-methacrylamidopropyl-N,N-dimethyl ammonium betaine, N,N-dimethylacrylamide, N-methylacrylamide, nonylphenoxypoly(ethyleneoxy)ethylmethacrylate, partially hydrolyzed polyacrylamide, poly 2-amino-2-methyl propane sulfonic acid, polyvinyl alcohol, sodium 2-acrylamido-2-methylpropane sulfonate, quaternized dimethylaminoethylacrylate, quaternized dimethylaminoethylmethacrylate, and derivatives and combinations thereof. In certain embodiments, the gelling agent comprises an acrylamide/2-(methacryloyloxy)ethyltrimethylammonium methyl sulfate copolymer. In certain embodiments, the gelling agent may comprise an acrylamide/2-(methacryloyloxy)ethyltrimethylammonium chloride copolymer. In certain embodiments, the gelling agent may comprise a derivatized cellulose that comprises cellulose grafted with an allyl or a vinyl monomer, such as those disclosed in U.S. Pat. Nos. 4,982,793, 5,067,565, and 5,122,549, the entire disclosures of which are incorporated herein by reference.

Additionally, polymers and copolymers that comprise one or more functional groups (e.g., hydroxyl, cis-hydroxyl, carboxylic acids, derivatives of carboxylic acids, sulfate, sulfonate, phosphate, phosphonate, amino, or amide groups) may be used as gelling agents.

The gelling agent may be present in the treatment fluids useful in the methods of the disclosure herein in an amount sufficient to provide the desired viscosity. In some embodiments, the gelling agents (i.e., the polymeric material) may be present in an amount in the range of from about 0.1% to about 10% by weight of the treatment fluid. In certain embodiments, the gelling agents may be present in an amount in the range of from about 0.15% to about 2.5% by weight of the treatment fluid.

In those embodiments of the disclosure herein where it is desirable to crosslink the gelling agent, the first treatment fluid and/or second treatment fluid may comprise one or more crosslinking agents. The crosslinking agents may comprise a borate ion, a metal ion, or similar component that is capable of crosslinking at least two molecules of the gelling agent. Examples of suitable crosslinking agents include, but are not limited to, borate ions, magnesium ions, zirconium IV ions, titanium IV ions, aluminum ions, antimony ions, chromium ions, iron ions, copper ions, magnesium ions, and zinc ions. These ions may be provided by providing any compound that is capable of producing one or more of these ions. Examples of such compounds include, but are not limited to, ferric chloride, boric acid, disodium octaborate tetrahydrate, sodium diborate, pentaborates, ulexite, colemanite, magnesium oxide, zirconium lactate, zirconium triethanol amine, zirconium lactate triethanolamine, zirconium carbonate, zirconium acetylacetonate, zirconium malate, zirconium citrate, zirconium diisopropylamine lactate, zirconium glycolate, zirconium triethanol amine glycolate, zirconium lactate glycolate, titanium lactate, titanium malate, titanium citrate, titanium ammonium lactate, titanium triethanolamine, and titanium acetylacetonate, aluminum lactate, aluminum citrate, antimony compounds, chromium compounds, iron compounds, copper compounds, zinc compounds, and combinations thereof. In certain embodiments of the disclosure herein, the crosslinking agent may be formulated to remain inactive until it is “activated” by, among other things, certain conditions in the fluid (e.g., pH, temperature, etc.) and/or interaction with some other substance. In some embodiments, the activation of the crosslinking agent may be delayed by encapsulation with a coating (e.g., a porous coating through which the crosslinking agent may diffuse slowly, or a degradable coating that degrades downhole) that delays the release of the crosslinking agent until a desired time or place. The choice of a particular crosslinking agent will be governed by several considerations that will be recognized by one skilled in the art, including but not limited to the following: the type of gelling agent included, the molecular weight of the gelling agent(s), the conditions in the subterranean formation being treated, the safety handling requirements, the pH of the treatment fluid, temperature, and/or the desired delay for the crosslinking agent to crosslink the gelling agent molecules.

When included, suitable crosslinking agents may be present in the treatment fluids useful in the methods of the disclosure herein in an amount sufficient to provide the desired degree of crosslinking between molecules of the gelling agent. In certain embodiments, the crosslinking agent may be present in the first treatment fluids and/or second treatment fluids of the disclosure herein in an amount in the range of from about 0.005% to about 1% by weight of the treatment fluid. In certain embodiments, the crosslinking agent may be present in the treatment fluids of the disclosure herein in an amount in the range of from about 0.05% to about 1% by weight of the first treatment fluid and/or second treatment fluid. One of ordinary skill in the art, with the benefit of this disclosure, will recognize the appropriate amount of crosslinking agent to include in a treatment fluid of the disclosure herein based on, among other things, the temperature conditions of a particular application, the type of gelling agents used, the molecular weight of the gelling agents, the desired degree of viscosification, and/or the pH of the treatment fluid.

In some embodiments, the retarded release comprises an emulsified acidizing agent. Suitable emulsifiers may be selected from the group consisting of polysorbates, alkyl sulfosuccinates, alkyl phenols, alkyl phenols, alkyl benzene sulfonates, ethoxylated fatty acid amines, fatty acid amines, stearyl alcohol, lecithin, fatty acids, ethoxylated fatty acids, propoxylated fatty acids, fatty acid salts, tall oils, castor oils, triglycerides, ethoxylated triglycerides, alkyl glucosides, and mixtures and derivatives thereof.

In some embodiments, the acidizing treatment fluid and other treatment fluids disclosed herein may comprise further additives selected from the group consisting of a surfactant, a corrosion inhibitor, an iron control agent, a buffer, and combinations thereof. In some embodiments, additional additives may include salts, weighting agents, inert solids, fluid loss control agents, emulsifiers, dispersion aids, corrosion inhibitors, emulsion thinners, emulsion thickeners, viscosifying agents, gelling agents, surfactants, particulates, proppants, gravel particulates, lost circulation materials, foaming agents, gases, pH control additives, breakers, biocides, crosslinkers, stabilizers, chelating agents, scale inhibitors, gas hydrate inhibitors, mutual solvents, oxidizers, reducers, friction reducers, clay stabilizing agents, and any combination thereof.

In some embodiments, the step of placing the acidizing treatment fluid in the subterranean formation may be performed as part of a completion and stimulation operation in a horizontal wellbore. In some embodiments, the step of placing the acidizing treatment fluid in the subterranean formation may be performed under sufficient pressure to promote acid fracturing. In some such embodiments, the treatment fluids disclosed herein may be used in conjunction with a hydrajet perforating, jetting while fracturing, and co-injection down the annulus technique. In some such embodiments, the acidizing treatment fluids of the disclosure herein may be used in conjunction with a SURGIFRAC™ process. SURGIFRAC™ processes have been applied mostly to horizontal or highly deviated well bores, for example, where casing the hole is difficult and expensive. Once a wellbore is drilled, and if deemed necessary cased, a hydrajetting tool, such as that used in the SURGIFRAC™ process, may be placed into the wellbore at a location of interest, e.g., adjacent to a first zone in the subterranean formation. In one exemplary embodiment, the hydrajetting tool is attached to a coil tubing, which lowers the hydrajetting tool into the wellbore and supplies it with jetting fluid. An annulus is formed between the coil tubing and the wellbore. The hydrajetting tool then operates to form perforation tunnels in the first zone. The perforation fluid being pumped through the hydrajetting tool contains a base fluid, which is commonly water and abrasives (commonly sand), and may also comprise a relative permeability modifier. The fluid is then injected into the first zone of the subterranean formation. As those of ordinary skill in the art will appreciate, the pressure of the fluid exiting the hydrajetting tool is sufficient to fracture the formation in the first zone. Using this technique, the jetted fluid forms cracks or fractures along perforation tunnels. In a subsequent step, the acidizing treatment fluids disclosed herein may be injected into the formation through the hydrajetting tool. In some embodiments, the acidizing treatment fluid may comprise a relative permeability modifier. The acidizing treatment fluid may etch the formation along the cracks thereby widening them. As those of ordinary skill in the art will recognize, the hydrajetting tool may have any number of jets, configured in a variety of combinations along and around the tool.

By using a hydrajetting technique, it is possible to generate one or more independent, single plane hydraulic fractures; and therefore, highly deviated or horizontal wells may be often completed without having to case the wellbore. Furthermore, even when highly deviated or horizontal wells are cased, hydrajetting the perforations and fractures in such wells generally may result in a more effective fracturing method than using traditional explosive charge perforation and fracturing techniques.

In some embodiments, the step of placing the acidizing treatment fluid in the subterranean formation may be performed as part of a matrix acidizing operation. In a matrix acidizing procedure, acidizing treatment fluids of the disclosure herein may be introduced into the subterranean formation via a well bore therein under pressure so that the acidic treatment fluid flows into the pore spaces of the formation and reacts with the acid-soluble materials therein. As a result, the pore spaces of that portion of the formation are enlarged, and consequently, the permeability of the formation should increase. The flow of hydrocarbons from the formation is therefore increased because of the increase in formation conductivity caused, inter alia, by dissolution of the formation material.

In some embodiments, the step of placing the acidizing treatment fluid in the subterranean formation may be performed to remove near-well formation damage and enhance well production. In some such embodiments, the acidizing treatment fluids of the invention can be used to restore permeability in such situations.

In some embodiments, the step of placing the acidizing treatment fluid in the subterranean formation may be performed as part of a gel breaking operation. During such operations, the acidizing treatment fluid comprising PESA may be employed to scavenge iron and other metals to prevent the formation of undesirable sludges. For example, the acidizing treatment fluids of the disclosure herein may be used to break down a gel after a diverting process, or other intervention in which a fluid loss agent is employed. For example, during drilling operations zones may be encountered which require the use of a crosslinked polymer to restrict the flow of fluids from the zones. Such instances may occur during drilling when high fluid-loss zones are encountered. In such instances, a general treatment of the entire formation with a crosslinkable polymer to form a gel to shut off the flow of fluids may be desirable. Such problems may be encountered, for example, in water injection wells where naturally-occurring or created fractures exist in the formation and the like. Typically, the use of the crosslinkable polymers may be best effective by plugging the entire formation area. While in some instances, this is desirable, in other instances it may be desirable to be able to produce hydrocarbons from the oil-bearing zones of the subterranean formation when the well is completed. In such instances it is necessary to remove the plugging polymer gels from the subterranean formation.

In some embodiments, the disclosure herein provides methods comprising providing treatment fluids comprising polyepoxysuccinic acid and placing the treatment fluid in a subterranean formation comprising ferric ion, ferrous ion, and mixtures thereof, whereby the treatment fluid sequesters ferric ion, ferrous ion, and mixtures thereof from the subterranean formation to prevent sludging in the subterranean formation. In some such embodiments, the polyepoxysuccinic acid may be present in a range from about 0.1 percent by weight of the acidizing treatment fluid to about 10 percent by weight of the treatment fluid. In some embodiments, such operations may be performed at temperatures in the subterranean formation which may be in a range from about ambient surface temperature to about 260° C. In some embodiments, the treatment fluids comprising polyepoxysuccinic acid can be introduced into the subterranean formation as a pre-treatment to bind metal ions present therein, for example, in a formation that may be prone to sludge formation due to the presence of iron ions in the formation. In other embodiments, the treatment fluid may be introduced as a remedial measure to remove or reduce sludge present as a result of the presence of iron and other metals which are prone to forming sludges.

In some embodiments, the disclosure herein provides methods comprising providing an acidizing treatment fluid comprising a polyepoxysuccinic acid and an acidizing agent; placing the acidizing treatment fluid in a subterranean formation; and sequestering a metal ion located therein. The metal ion may be derived from any suitable metal, including, but not limited to, iron, magnesium, calcium, transition metal, or any derivative or combination thereof.

In some embodiments, the disclosure herein provides methods comprising providing treatment fluids comprising polyepoxysuccinic acid, placing the treatment fluid in a subterranean formation comprising a sludge, the sludge comprising ferric ion, ferrous ion, and mixtures thereof, whereby the treatment fluid sequesters ferric ion, ferrous ion, and mixtures thereof from the sludge resulting in a broken down sludge in the subterranean formation, and the method comprising removing the broken down sludge from the subterranean formation. In some embodiments, the polyepoxysuccinic acid may be present in a range from about 0.1 percent by weight of the acidizing treatment fluid to about 10 percent by weight of the treatment fluid.

In some embodiments, in methods for breaking down a sludge, the sludge may be naturally occurring or a sludge that is produced from a prior acidizing treatment. In some embodiments, methods of the invention for breaking down a sludge may further comprise introducing a water-dispersible emulsion breaker. This may be provided at the same time as the PESA reagent or separately and in any order. Suitable emulsion breakers may include, without limitation, dodecylbenzylsulfonic acid, the sodium salt of xylenesulfonic acid, alkyoxylated compounds, anionic cationic and nonionic surfactants, and resins.

To facilitate a better understanding of the disclosure herein, the following examples of preferred or representative embodiments are given. In no way should the following examples be read to limit, or to define, the scope of the invention.

### EXAMPLES

Laboratory testing was conducted to determine the potential effectiveness of PESA in sequestering iron. The following procedure was used. 50 mL of de-ionized water were measured into a beaker. The iron control agent was added slowly to the test solution with continuous stirring. A desired amount of ferric chloride was added to the test solution. The ferric chloride solution was mixed thoroughly. Next 1 N sodium hydroxide was added to the test solution to adjust the pH to 7 or more. The test solution maintained at the desired temperature for 3 hours. After 3 hours the test solution was filtered using Whatman No. 40 filter paper and iron analysis was conducted. Dissolved iron was measured using inductively coupled plasma (ICP) testing. The results are shown below in Table 1.

TABLE 1

| | TEMP | | | IRON CONTROL | DISSOLVED IRON |
|---|---|---|---|---|---|
| ENTRY | (° F.) | TIME | ADDITIVE | AGENT | CONCENTRATION (PPM) |
| 1 | 200 | 3 | 0.5 wt % | None | <1 |
| | | | FeCl₃ | | |
| 2 | 200 | 3 | 0.5 wt % | 0.6 wt % Fe-2 ™ + | 1247 |
| | | | FeCl₃ | 2 vol % Fe-1A ™ | |
| 3 | 200 | 3 | 0.5 wt % | 2 vol % PESA | 1340 |
| | | | FeCl₃ | | |

Table 1 shows that PESA exhibits good iron control characteristics at 200° F. The PESA reagent exhibits improved iron sequestration relative to the known iron control agent mixture Fe-2™ and Fe-1A™ (Halliburton, Duncan, Okla.).

Therefore, the disclosure herein is well adapted to attain the ends and advantages mentioned as well as those that are inherent therein. The particular embodiments disclosed above are illustrative only, as the disclosure herein may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the disclosure herein. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A method comprising:
providing an acidizing treatment fluid comprising a polyepoxysuccinic acid and an acidizing agent;
placing the acidizing treatment fluid in a subterranean formation; and
sequestering a metal ion located therein.

2. The method of claim 1, wherein the metal ion is derived from a metal selected from the group consisting of: iron, magnesium, a transition metal, and any derivative and combination thereof.

3. The method of claim 1, wherein the polyepoxysuccinic acid is present in a range from about 0.1 percent by weight of the acidizing treatment fluid to about 10 percent by weight of the acidizing treatment fluid.

4. The method of claim 1, wherein a downhole temperature in the subterranean formation is in a range from about ambient surface temperature to about 260° C.

5. The method of claim 1, wherein the acidizing agent comprises one selected from the group consisting of hydrochloric acid, hydrofluoric acid, acetic acid, formic acid, sulfamic acid, and chloroacetic acid.

6. The method of claim 1, wherein the acidizing agent is provided in a retarded release formulation.

7. The method of claim 6, wherein the retarded release formulation comprises a gelling agent.

8. The method of claim 6, wherein the retarded release formulation comprises an emulsified acidizing agent.

9. The method of claim 1, wherein the acidizing treatment fluid comprises one selected from the group consisting of a surfactant, a corrosion inhibitor, an iron control agent, a buffer, and combinations thereof.

10. The method of claim 1, wherein the step of placing the acidizing treatment fluid in the subterranean formation is performed as part of a completion and stimulation operation in a horizontal wellbore.

11. The method of claim 1, wherein the step of placing the acidizing treatment fluid in the subterranean formation is performed as part of a matrix acidizing operation.

12. The method of claim 1, wherein the step of placing the acidizing treatment fluid in the subterranean formation is performed under sufficient pressure to promote acid fracturing.

13. The method of claim 1, wherein the step of placing the acidizing treatment fluid in the subterranean formation is performed to remove near-well formation damage and enhance well production.

14. The method of claim 1, wherein the step of placing the acidizing treatment fluid in the subterranean formation is performed as part of a gel breaking operation.

15. The method of claim 1, wherein the step of placing the acidizing treatment fluid in the subterranean formation is performed to remove a sludge.

16. A method comprising:
providing a treatment fluid comprising a polyepoxysuccinic acid; and
placing the treatment fluid in a subterranean formation comprising ferric ion, ferrous ion, and mixtures thereof;
whereby the treatment fluid sequesters at least one selected from the group consisting of: ferric ion, ferrous ion, and mixtures thereof, from the subterranean formation to prevent sludging in the subterranean formation.

17. The method of claim 16, wherein the polyepoxysuccinic acid is present in a range from about 0.1 percent by weight of the treatment fluid to about 10 percent by weight of the treatment fluid.

18. The method of claim 16, wherein a downhole temperature in the subterranean formation is in a range from about ambient surface temperature to about 260° C.

19. A method comprising:
providing a treatment fluid comprising a polyepoxysuccinic acid;
placing the treatment fluid in a subterranean formation comprising a sludge, the sludge comprising ferric ion, ferrous ion, and mixtures thereof;
whereby the treatment fluid sequesters at least one selected from the group consisting of: ferric ion, ferrous ion, and mixtures thereof from the sludge resulting in a broken down sludge in the subterranean formation; and
removing the broken down sludge from the subterranean formation.

20. The method of claim 19, wherein the polyepoxysuccinic acid is present in a range from about 0.1 percent by weight of the treatment fluid to about 10 percent by weight of the treatment fluid.
